(19) United States
(12) Patent Application Publication
(10) Pub. No.: US 2025/0297169 A1
(43) Pub. Date: Sep. 25, 2025

(54) Processes and Systems for Fractionating a Pyrolysis Effluent

(71) Applicant: ExxonMobil Chemical Patents Inc., Spring, TX (US)

(72) Inventors: James R. Arnold, Highlands Ranch, CO (US); Selma S. Lawrence, Houston, TX (US); Vikram Singh, Houston, TX (US)

(21) Appl. No.: 18/863,213

(22) PCT Filed: May 31, 2023
(86) PCT No.: PCT/US2023/023969

§ 371 Date: Nov. 5, 2024

Related U.S. Application Data
(60) Provisional application No. 63/354,252, filed on Jun. 22, 2022.

(51) Int. Cl. C10G 7/00; B01D 3/16; B01J 19/24

(52) U.S. Cl. CPC C10G 7/006; B01D 3/16; B01J 19/24

(57) ABSTRACT

Processes and systems for fractionating a pyrolysis effluent. The effluent can be separated into a first liquid and a first vapor within a flash zone of a primary' fractionator. A pyrolysis tar can be recovered from the flash zone. The first vapor can flow into a quench zone and can be contacted with a first quench medium to produce a. second liquid and a second vapor. A pyrolysis quench oil can be recovered from the quench zone. The second vapor can flow into a fractionation zone and can be contacted with a second quench medium. A pyrolysis gas oil and a process gas can be recovered from the fractionation zone. Heat can be indirectly transferred from the pyrolysis quench oil to a heat transfer medium to produce a cooled pyrolysis quench oil. The first quench medium can include at least a portion of the cooled pyrolysis quench oil.

### CROSS-REFERENCE TO RELATED APPLICATION

This application claims priority to and the benefit of U.S. Provisional Application No. 63/354,252 having a filing date of Jun. 22, 2022, the disclosure of which is incorporated herein by reference in its entirety.

### FIELD

Embodiments disclosed herein generally relate to processes and systems for separating a pyrolysis effluent into a plurality of products.

### BACKGROUND

Pyrolysis effluents produced by pyrolysis processes, e.g., steam cracking, include saturated hydrocarbons that have been converted to higher value products, e.g., light olefins, such as ethylene and propylene. The products are typically separated via a fractionator commonly referred to as a primary fractionator. In addition to the higher value products, other products such as naphtha, gas oil, and quench oil are also recovered via the primary fractionator.

The processing conditions within a pyrolysis environment produce chemical species that cause fouling of structures and/or surfaces within conventional primary fractionators and erosion within associated equipment such as pumps and piping. Conventional primary fractionators also produce products having a relatively poor product quality and require a high quench oil make-up requirement. These issues can restrict operations and lead to premature shutdown, erosion within pumps, piping, and/or quench fittings, less valuable and less marketable products, and/or increased costs associated with the additional quench oil make-up.

There is a need, therefore, for improved processes and systems for fractionating a pyrolysis effluent.

### SUMMARY

Processes and systems for fractionating a pyrolysis effluent are provided. In some embodiments, the process for fractionating a pyrolysis effluent can include introducing a pyrolysis effluent into a flash zone located within a fractionator. The pyrolysis effluent can be separated into a first liquid phase fraction and a first vapor phase fraction within the flash zone. A pyrolysis tar that can include the first liquid phase fraction can be recovered from the flash zone. The first vapor phase fraction can flow into a quench zone disposed above the flash zone. The first vapor phase fraction can be contacted with a first quench medium within the quench zone to produce a second liquid phase fraction and a second vapor phase fraction. A pyrolysis quench oil that can include the second liquid phase fraction and at least a portion of the first quench medium can be recovered from the quench zone. The second vapor phase fraction can flow into a fractionation zone disposed above the quench zone. The second vapor phase fraction can be contacted with a second quench medium within the fractionation zone to produce a third liquid phase fraction and a third vapor phase fraction. A pyrolysis gas oil that can include the third liquid phase fraction can be recovered from the fractionation zone. The third vapor phase fraction that can include at least a portion of the second quench medium and a process gas that can include ethylene can be recovered from the fractionation zone. Heat can be indirectly transferred from at least a portion of the pyrolysis quench oil to a heat transfer medium in a heat exchange stage to produce a cooled pyrolysis quench oil and a heated heat transfer medium. The first quench medium can be or can include at least a portion of the cooled pyrolysis quench oil.

In some embodiments, a primary fractionator for a pyrolysis system can include a flash zone that can include a pyrolysis effluent inlet and a pyrolysis tar outlet. A quench zone can be disposed above the flash zone and can include a pyrolysis quench oil inlet and a pyrolysis quench oil outlet. A vapor distribution device can be disposed between the flash zone and the quench zone. The vapor distribution device can be configured to allow a vapor to flow therethrough from the flash zone and into the quench zone. The vapor distribution device can also be configured to collect a liquid thereon within the quench zone. A fractionation section can be disposed above the quench zone and can include a pyrolysis gas oil outlet, a vapor phase outlet, and a reflux inlet.

In some embodiments, a system for producing and processing a pyrolysis effluent can include a pyrolysis reactor that can include a pyrolysis effluent outlet. The system can also include a quench fitting that can include a first inlet in fluid communication with the pyrolysis effluent outlet, a second inlet, and an outlet. The quench fitting can be configured to mix a pyrolysis effluent introduced into the first inlet and a quench medium introduced into the second inlet to produce a cooled pyrolysis effluent. The system can also include a primary fractionator. The primary fractionator can include a flash zone, a quench zone, a vapor distribution device, and a fractionation section. The flash zone can include a pyrolysis effluent inlet and a pyrolysis tar outlet. The quench zone can be disposed above the flash zone and can include a pyrolysis quench oil inlet and a pyrolysis quench oil outlet. A vapor distribution device can be disposed between the flash zone and the quench zone. The vapor distribution device can be configured to allow a vapor to flow therethrough from the flash zone and into the quench zone. The vapor distribution device can also be configured to collect a liquid thereon within the quench zone. A fractionation section can be disposed above the quench zone and can include a pyrolysis gas oil outlet, a vapor phase outlet, and a reflux inlet.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic of an illustrative system for separating a plurality of products, e.g., a pyrolysis tar, a pyrolysis quench oil, a pyrolysis gas oil, and an overhead, from a cooled pyrolysis effluent, according to one or more embodiments described.

FIG. 2 depicts a schematic of an illustrative system for steam cracking a hydrocarbon feed to produce a steam cracker effluent and separating a plurality of products therefrom, according to one or more embodiments described.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

### Definitions

The indefinite article “a” or “an”, as used herein, means “at least one” unless specified to the contrary or the context clearly indicates otherwise. Thus, embodiments using “a separator” include embodiments where one or two or more separators are used, unless specified to the contrary or the context clearly indicates that only one separator is used. Likewise, embodiments using “a separation stage” include embodiments where one or two or more separation stages are used, unless specified to the contrary.

As used herein, the term “hydrocarbon” means a class of compounds containing hydrogen bound to carbon. The term “Cₙ” hydrocarbon means hydrocarbon having n carbon atom(s) per molecule, where n is a positive integer. The term “Cₙ₊” hydrocarbon means hydrocarbon having at least n carbon atom(s) per molecule, where n is a positive integer. The term “Cₙ₋” hydrocarbon means hydrocarbon having no more than n number of carbon atom(s) per molecule, where n is a positive integer. “Hydrocarbon” encompasses (i) saturated hydrocarbon, (ii) unsaturated hydrocarbon, and (iii) mixtures of hydrocarbons, including mixtures of hydrocarbon compounds (saturated and/or unsaturated), including mixtures of hydrocarbon compounds having different values of n.

The term “unsaturate” or “unsaturated hydrocarbon” means a C₂₊ hydrocarbon containing at least one carbon atom directly bound to another carbon atom by a double or triple bond. The term “olefin” means an unsaturated hydrocarbon containing at least one carbon atom directly bound to another carbon atom by a double bond. In other words, an olefin is a compound that contains at least one pair of carbon atoms, where the first and second carbon atoms of the pair are directly linked by a double bond. “Light olefin” means C₅-olefinic hydrocarbon.

The term “primarily liquid phase” means a composition of which ≥50 wt. % is in the liquid phase, e.g., ≥75 wt. %, such as ≥90 wt. %. A hydrocarbon feedstock is a primarily liquid-phase hydrocarbon feedstock when ≥50 wt. % of the hydrocarbon feedstock is in the liquid phase at a temperature of 25° C. and a pressure of 1 bar absolute, e.g., ≥75 wt. %, such as ≥90 wt. %.

The term “raw” feedstock, e.g., raw hydrocarbon feedstock, means a primarily liquid-phase feedstock that comprises ≥25 wt. % of crude oil that has not been subjected to prior desalting and/or prior fractionation with reflux, e.g., ≥50 wt. %, such as ≥75 wt. %, or ≥90 wt. %.

The term “crude oil” means a mixture comprising naturally-occurring hydrocarbon of geological origin, where the mixture (i) comprises ≥1 wt. % of resid. e.g., ≥5 wt. %, such as ≥10 wt. %, and (ii) has an API gravity ≤52°, e.g., ≤30°, such as ≤20°, or ≤10°, or <8°. The crude oil can be classified by API gravity, e.g., heavy crude oil has an API gravity in the range of from 5° up to (but not including) 22°.

Normal boiling point and normal boiling point ranges can be measured by gas chromatograph distillation according to the methods described in ASTM D-6352-98 or D2887, as extended by extrapolation for materials above 700° C. The term “To” means a temperature, determined according to a boiling point distribution, at which 50 weight percent of a particular sample has reached its boiling point. Likewise, “T₉₀”, “T₉₅” and “T₉₈” mean the temperature at which 90, 95, or 98 weight percent of a particular sample has reached its boiling point. Nominal final boiling point means the temperature at which 99.5 weight percent of a particular sample has reached its boiling point.

Certain medium and/or heavy hydrocarbons, e.g., certain raw hydrocarbon feedstocks, such as certain crude oils and crude oil mixtures contain one or more of asphaltenes, precursors of asphaltenes, and particulates. Asphaltenes are described in U.S. Pat. No. 5,871,634. Asphaltene content can be determined using ASTM D6560-17. Asphaltenes in the hydrocarbon can be in the liquid phase (e.g., a miscible liquid phase), and also in a solid and/or semi-solid phase (e.g., as a precipitate). Asphaltenes and asphaltene precursors are typically present in a resid portion of a crude oil. “Resid” means an oleaginous mixture, typically contained in or derived from crude oil, the mixture having a normal boiling point range ≥566° C. Resid can include “non-volatile components”, meaning compositions (organic and/or inorganic) having a normal boiling point range ≥590° C. Non-volatile components may be further limited to components with a boiling point of about 760° C., or greater. Non-volatile components may include coke precursors, which are moderately heavy and/or reactive molecules, such as multi-ring aromatic compounds, which can condense from the vapor phase and then form coke under the specified steam cracking conditions. Medium and/or heavy hydrocarbons (particularly the resid portion thereof) may also contain particulates, meaning solids and/or semi-solids in particle form. Particulates may be organic and/or inorganic, and can include coke, ash, sand, precipitated salts, etc. Although precipitated asphaltenes may be solid or semi-solid, precipitated asphaltenes are considered to be in the class of asphaltenes, not in the class of particulates.

### Hydrocarbon Fractionation

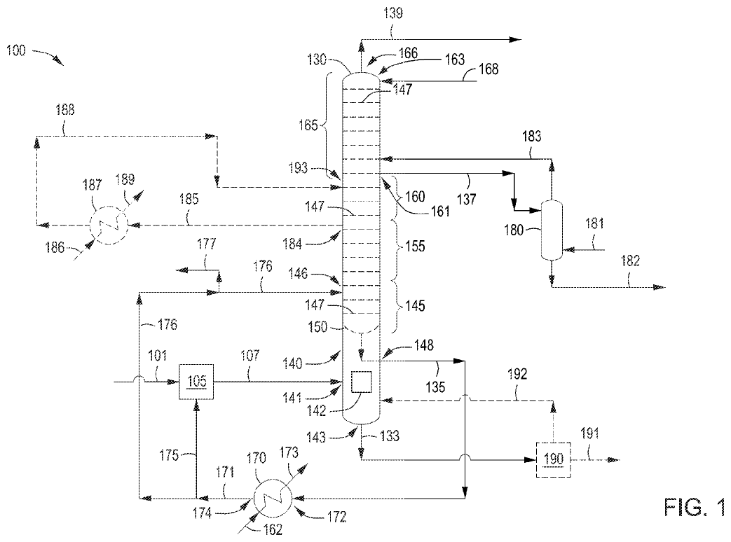

FIG. 1 depicts a schematic of an illustrative system 100 for separating a plurality of products, e.g., a pyrolysis tar via line 133, a pyrolysis quench oil via line 135, a pyrolysis gas oil via line 137, and an overhead via line 139, from a cooled pyrolysis effluent introduced via line 107, according to one or more embodiments. The system 100 can include a primary fractionator 130. The primary fractionator 130 can include a flash zone 140 that can include a pyrolysis effluent inlet 141 and a pyrolysis tar outlet 143. In some embodiments, the pyrolysis effluent inlet 141 can be in fluid communication with a feed distribution device 142. The feed distribution device 142, if present, can be or can include, but is not limited to, a vapor horn, an annular ring, a V-baffle, a perforated pipe distributor, a dual flow tray, or any combination thereof.

A quench zone 145 can be disposed above the flash zone 140 and can include a pyrolysis quench oil inlet 146 and a pyrolysis quench oil outlet 148. A vapor distribution device 150 can be disposed between the flash zone 140 and the quench zone 145. The vapor distribution device 150 can be configured to allow a vapor to flow therethrough from the flash zone 140 and into the quench zone 145. In some embodiments, the vapor distribution device 150 can also be configured to collect liquid thereon within the quench zone 145. The liquid collected on the vapor distribution device 150 can be a pyrolysis quench oil that can be recovered therefrom via line 135 in fluid communication with the pyrolysis quench oil outlet 148. In some embodiments, the vapor distribution device 150 can be a chimney tray, a dual flow tray, a baffle tray, or the like. In other embodiments, one or more internal structures 147 can be disposed within the quench zone 145 and at least one internal structure 147, e.g., a bottom draw off tray, can be configured to collect the pyrolysis quench oil thereon that can be recovered therefrom via line 135 in fluid communication with the pyrolysis quench oil outlet 148.

The primary fractionator 130 can also include one or more fractionation zones, e.g., fractionation zones 155 and/or 165 disposed above the quench zone 145 that can include a pyrolysis gas oil outlet 161, a vapor phase outlet 166, and a reflux inlet 163. As shown, in some embodiments, the fractionator 130 can include a lower fractionation zone 155, an upper fractionation zone 165, and a pump around zone 160 disposed between the lower fractionation zone 155 and the upper fractionation zone 165. It should be understood, however, that the primary fractionator 130 can include only one or two of the lower fractionation zone 155, the pump around zone 160, and the upper fractionation zone 165.

In some embodiments, one or more of the quench zone 145, the lower fractionation zone 155, the pump around zone 160, and the upper fractionation zone 165 can independently include one or more internal structures 147. The internal structure(s) 147 can facilitate vapor/liquid separation and/or liquid collection. Illustrative internal structures 147 can include, but are not limited to, trays, grids, packing, or any combination thereof. Illustrative trays can include, but are not limited to, fixed valve trays, jet tab trays, sieve trays, dual flow trays, baffle trays, angle iron trays, draw off trays, chimney trays, shed deck trays, disk trays, donut trays, side by side-splash trays, or any combination thereof. Suitable fixed valve trays, sieve trays, dual flow trays, and grids can include those disclosed in Distillation Design, Henry Z. Kister, McGraw-Hill Inc., 1992, pages 262 to 265 and pages 464-466. Suitable jet tab trays can include those disclosed in WO Publication No. WO2011/014345.

In some embodiments, the quench zone 145, the lower fractionation zone 155, the pump around zone 160, and the upper fractionation zone 165 can independently include 1, 2, 3, 4, 5, 6, 7, 8, 9, 10, or more internal structures 147, e.g., trays such as jet tab trays, dual flow trays, multiple pass trays, and/or baffle trays. In some embodiments the quench zone 145, the lower fractionation zone 155, the pump around zone 160, and the upper fractionation zone 165 can independently include 1, 2, 3, 4, 5, 6, 7, 8, 9, 10 or more internal structures 147, e.g., trays such as jet tab trays, dual flow trays, multiple pass trays, and/or baffle trays, having 2, 3, 4, 5, 6, or more liquid passes.

The pyrolysis quench oil via line 135 and a heat transfer medium or “first” heat transfer medium via line 162 can be introduced into one or more heat exchange stages 170 via an inlet 172 to produce a cooled pyrolysis quench oil in line 171 and via an outlet 174 a heated heat transfer medium in line 173. In some embodiments, all of the pyrolysis quench oil recovered via line 135 from the primary fractionator 130 can be introduced into the heat exchange stage 170. In other embodiments, a first portion of the quench oil recovered via line 135 from the primary fractionator can be introduced into the heat exchange stage 170 and a second portion can be removed from the system 100. In some embodiments, the pyrolysis quench oil recovered via line 135 from the primary fractionator 130 can be introduced into the heat exchange stage 170 without being subjected to any filtration or other particle removal process. In other embodiments, the pyrolysis quench oil recovered via line 135 from the primary fractionator 130 can be subjected to filtration or other particle removal process prior to being introduced into the heat exchange stage 170.

In some embodiments, the pyrolysis quench oil in line 135, upon exiting the primary fractionator 130, can be at a temperature of about 185° C., about 200° C., or about 210° C. to about 225° C., about 240° C., or about 250° C. In some embodiments, the cooled pyrolysis quench oil in line 171 can be at a temperature of about 140° C., about 150° C., or about 160° C. to about 180° C., about 190° C., or about 200° C. The heat transfer medium can be or can include, but is not limited to, water, steam, a mixture of water and steam, air, or any combination thereof. As such, the heat exchange stage 170 can include one or more heat exchangers configured to transfer heat from the pyrolysis quench oil to water and/or steam and/or the heat exchange stage 170 can include one or more heat exchangers configured to transfer heat from the pyrolysis quench oil to air, e.g., an air fin equipped heat exchanger.

It should be understood that the heat exchange stage 170 can include two or more heat exchange stages in series and/or in parallel. In some embodiments, a first heat exchange stage can preheat boiler feed water, a second heat exchange stage can produce dilution steam, a third heat exchange stage can produce medium pressure stream, a fourth heat exchange stage can produce low pressure steam, and/or a fifth heat exchange stage that can be used for trim cooling, e.g., to cool or heat other steams such as a feed into a steam cracker furnace. In some embodiments, the heated heat transfer medium in line 173 can be or can include, but is not limited to, low pressure steam at a pressure of about 100 kPag to <827 kPag and/or or a medium pressure steam at a pressure of about 827 kPag to about 1,720 kPag, or a combination thereof. In some embodiments, the amount of medium pressure steam produced by cooling the pyrolysis quench oil in the heat exchange stage 170 can be about 0.3, about 0.35 or about 0.4 to about 0.45, about 0.5, or about 0.55 tonnes per tonne of a pyrolysis effluent in line 101 ultimately introduced into the primary fractionator 130.

A first portion of the cooled pyrolysis quench oil via line 175 can be mixed, blended, or otherwise combined with the pyrolysis effluent in line 101, e.g., within one or more quench fittings 105, to produce the cooled pyrolysis effluent in line 107. In some embodiments, the pyrolysis effluent in line 101 can be at a temperature of about 550° C., about 625° C., or about 700° C. to about 800° C., about 900° C., or about 1,000° C. In some embodiments, the cooled pyrolysis effluent in line 107 can be at a temperature of ≤350° C., ≤325° C., ≤275° C., 250° C., or ≤235° C. In some embodiments, the amount of cooled pyrolysis quench oil in line 175 contacted with the pyrolysis effluent in one 101 can vary considerably from facility to facility, but the cooled pyrolysis quench oil to pyrolysis effluent weight ratio is typically in the range of about 0.1:1 to about 10:1, e.g., about 0.5:1 to about 5:1, such as about 1:1 to about 4:1.

In some embodiments, a second portion of the cooled pyrolysis quench oil via line 176 can be recycled into the quench zone 145 through the pyrolysis quench oil inlet 146 as a quench medium. In some embodiments, a third portion of the cooled pyrolysis quench oil can be removed via line 177 from the system.

The cooled pyrolysis effluent in line 107 can be introduced into the flash zone 140 via the pyrolysis effluent inlet 141. In some embodiments, the cooled pyrolysis effluent in line 107 can be at a temperature of about 225° C. about 240° C., about 250° C., about 260° C. about 270° C., or about 280° C. to about 300° C. about 325° C., or about 350° C. when introduced into the flash zone 140. In some embodiments, the cooled pyrolysis effluent in line 107 can be at a temperature of ≥225° C., ≥235° C., ≥250° C., or ≥265° C. and ≤350° C., ≤325° C., or ≤315° C. when introduced into the flash zone 140. The cooled pyrolysis effluent can separate into a first liquid phase fraction and a first vapor phase fraction within the flash zone 140. The first liquid phase fraction can be recovered therefrom as the pyrolysis tar via line 133 in fluid communication with the pyrolysis tar outlet 143. The first liquid phase fraction or pyrolysis tar, upon exiting the pyrolysis tar outlet 143, can be at a temperature of about 225° C. about 250° C., or about 265° C. to about 285° C., about 300° C., about 315° C., about 325° C., or about 350° C.

In some embodiments, the pyrolysis tar via line 133 can be introduced into an optional upgrading unit 190 to produce an upgraded heavy fuel oil via line 191 and an overhead via line 192. In some embodiments, the upgrading unit 190 can include one or more hydroprocessing stages. The pyrolysis tar can be hydroprocessed in the upgrading unit 190 in the presence of molecular hydrogen and a catalyst under tar hydroprocessing conditions sufficient to produce the upgraded heavy fuel oil via line 191. The overhead in line 192, which can include molecular hydrogen, can be introduced into the flash zone 140. Illustrative processes and systems that can be used to hydroprocess the pyrolysis tar can include those disclosed in U.S. Pat. Nos. 9,090,836; 9,637,694; and 9,777,227; and International Patent Application Publication No. WO 2018/111574.

The first vapor phase fraction can flow through the vapor distribution device 150 and into the quench zone 145. The first vapor phase fraction can be at a temperature of about 235° C., about 250° C., or about 265° C. to about 285° C., about 300° C., or about 315° C. as the first vapor phase fraction flows into the quench zone 145. The first vapor phase fraction can be contacted with a first quench medium. e.g., the second portion of the cooled pyrolysis quench oil introduced via line 176, within the quench zone to produce a second liquid phase fraction and a second vapor phase fraction. In some embodiments, the first quench medium can also include, in addition to the second portion of the cooled pyrolysis quench oil, one or more additional quench mediums imported into the process such as a quench oil produced in another process. In some embodiments, the cooled pyrolysis quench oil via line 176 can be introduced into the primary fractionator 130, relative to a weight of hydrocarbons in the cooled pyrolysis effluent in line 107, at a weight ratio of about 7:1, about 9:1, or about 10:1 to about 12:1, about 13:1, or about 15:1.

The second liquid phase fraction can collect on the vapor distribution device 150 and/or on one or more internal structures 147 disposed within the quench zone 145, and can be recovered from the quench zone 145 as the pyrolysis quench oil via line 135 in fluid communication with the pyrolysis quench oil outlet 148. The one or more internal structures 147, if present, can facilitate separation of the second vapor phase fraction and the second liquid phase fraction. The second vapor phase fraction can be at a temperature of about 160° C., about 170° C., or about 175° C. to about 185° C., about 195° C., or about 200° C. as the second vapor phase fraction flows into the lower fractionation zone 155.

The weight ratio of the pyrolysis quench oil to the pyrolysis tar can depend, at least in part, on the hydrocarbon feed that is subjected to pyrolysis to produce the pyrolysis effluent. In some embodiments, the weight ratio of pyrolysis quench oil in line 177 to the pyrolysis tar in line 133 recovered from the primary fractionator 130 can be about 15:1, 20:1, 25:1, 30:1, 40:1, or 50:1 to 90:1, 100:1, 120:1, 140:1, 160:1, 180:1, or 200:1. In other embodiments, the weight ratio of the pyrolysis quench oil in line 177 to the pyrolysis tar in line 133 recovered from the primary fractionator 130 can be ≥15:1, ≥20:1, ≥30:1, ≥1:50, ≥70:1, ≥85:1, or ≥100:1.

It has been discovered that when the cooled pyrolysis effluent in line 107 includes coke particles, the coke particles can be removed with the pyrolysis tar in line 133 and/or can remain within the flash zone 140, thus allowing the first vapor phase fraction to flow into the quench zone 145 substantially free of coke particles. In some embodiments, when the cooled pyrolysis effluent includes coke particles, the pyrolysis quench oil in line 135 can include ≤10 wt %, ≤5 wt %, ≤3 wt %, ≤1 wt %, or ≤0.5 wt % of the coke particles present in the cooled pyrolysis effluent in line 107. In other embodiments, the pyrolysis quench oil in line 135 can be free of coke particles. In some embodiments, the pyrolysis tar in line 133 can include about 50 wt %, about 70 wt %, or about 80 wt % to about 90 wt %, about 95 wt %, about 99 wt %, or about 99.5 wt % of the coke particles present in the cooled pyrolysis effluent in line 107. In some embodiments, about 0.5 wt %, about 1 wt %, or about 3 wt % to about 10 wt %, about 20 wt %, or about 25 wt % of the coke particles present in the cooled pyrolysis effluent in line 107 can remain within the flash zone 140. In some embodiments, ≥50 wt %, ≥60 wt %, ≥70 wt %, ≥80 wt %, ≥85 wt %, ≥90 wt %, or ≥95 wt % of any coke particles not removed from the fractionator 130 via the tar product in line 133 can remain in the flash zone 140. Coke particles that remain within the flash zone 140 can be removed during routine maintenance operations.

It has also been discovered that when the cooled pyrolysis effluent in line 107 includes asphaltenes, the asphaltenes can, for the most part, be removed with the pyrolysis tar in line 133 and/or can remain within the flash zone 140, thus allowing the first vapor phase fraction to flow into the quench zone with that can be substantially free of asphaltenes. In some embodiments, when the cooled pyrolysis effluent in line 107 includes asphaltenes, the pyrolysis quench oil in line 135 can include ≤20 wt %, ≤10 wt %, or ≤5 wt % of the asphaltenes present in the cooled pyrolysis effluent in line 107. In other embodiments, the pyrolysis quench oil in line 135 can be free of asphaltenes. In some embodiments, the pyrolysis tar in line 133 can include about 80 wt %, about 85 wt %, or about 90 wt % to about 93 wt %, about 95 wt %, about 96 wt % or more of the asphaltenes present in the cooled pyrolysis effluent in line 107. In some embodiments, about 1 wt %, about 3 wt %, or about 5 wt % to about 10 wt %, about 15 wt %, or about 20 wt % of the asphaltenes present in the cooled pyrolysis effluent in line 107 can remain within the flash zone. Asphaltenes that remain within the flash zone 140 can be removed during routine maintenance operations. In some embodiments, the pyrolysis quench oil in line 135 can include ≤30 wt %, ≤15 wt %, ≤10 wt %, ≤5 wt, or ≤1 wt % of a combined amount of any coke and any asphaltenes present in the cooled pyrolysis effluent in line 107.

It has also been discovered that by separating the pyrolysis tar from the pyrolysis effluent within the flash zone 140 rather than within a conventional primary fractionator, the viscosity of the pyrolysis quench oil in line 135 can be significantly reduced. In some embodiments, the pyrolysis quench oil in line 135 can have a viscosity of ≤10 cP, ≤7 cP, ≤5 cP, ≤4.5 cP, ≤4 cP, ≤3.5 cP, ≤3 cP, or ≤2.9 cP at a temperature of about 60° C., as measured according to ASTM D2171/D2171M-18. In contrast, when the cooled pyrolysis effluent is introduced into a conventional primary fractionator and a bottoms containing the pyrolysis tar and the pyrolysis quench oil, typically referred to as a fuel oil bottoms, is recovered as the bottoms product, such product typically has a viscosity that is significantly greater than 10 cP, as measured according to ASTM D2171/D2171M-18.

It has also been discovered that by separating the pyrolysis tar from the pyrolysis effluent within the flash zone 140, the amount of insoluble polymer that can be produced in the pyrolysis quench oil in line 135 under process conditions the pyrolysis quench oil is typically subjected to can be decreased or even eliminated. In some embodiments, the pyrolysis quench oil in line 135, when heat soaked at a temperature of about 160° C. for 6 hours can produce ≤15 wppm, ≤12 wppm, ≤10 wppm, ≤8 wppm, ≤6 wppm, ≤5 wppm, ≤3 wppm, or ≤1 wppm of insoluble polymer. In other embodiments, the pyrolysis quench oil in line 135, when heat soaked at a temperature of about 160° C. for 6 hours can be free or essentially free of any detectable insoluble polymer. In contrast, when the cooled pyrolysis effluent is introduced into a conventional primary fractionator and a bottoms containing the pyrolysis tar and the pyrolysis quench oil is recovered as the bottoms product, such bottoms product when heat soaked at a temperature of about 160° C. for 6 hours typically has >15 wppm of insoluble polymer, such as about 16 wppm to about 20 wppm or more.

It has also been discovered that by separating the pyrolysis tar from the pyrolysis effluent within the flash zone 140, the amount of pyrolysis quench oil recovered via line 135 from the quench zone 145 can be increased. The amount of pyrolysis quench oil can be increased because the pyrolysis tar can be separated from the pyrolysis effluent at a greater temperature within the flash zone 140 as compared to if the cooled pyrolysis effluent is introduced into a conventional primary fractionator that provides a bottoms product containing the pyrolysis tar and the pyrolysis quench oil that is then separated into the pyrolysis quench oil and the pyrolysis tar. As such the amount of the more valuable quench oil molecules that would otherwise be recovered as a component of the pyrolysis tar can be reduced. By increasing the amount of quench oil recovered, the need to import quench oil can be reduced or even eliminated.

Returning to the second vapor phase fraction, the second vapor phase fraction can flow through the lower fractionation zone 155, through the pump around zone 160, and into the upper fractionation zone 165 and can be contacted with a second quench medium introduced through the reflux inlet 163 via line 168 into the upper fractionation zone 165 to produce a third liquid phase fraction and a third vapor phase fraction. The third liquid phase fraction via line 137 in fluid communication with the pyrolysis gas oil outlet 161 can be recovered from the upper fractionation zone 165 as the pyrolysis gas oil. In some embodiments, the pyrolysis gas oil via line 137 can be recovered from a lower portion of the upper fractionation zone 165. In some embodiments, the pyrolysis gas oil, upon exiting the pyrolysis gas oil outlet 161 via line 137 can be at a temperature of about 120° C., about 125° C., or about 130° C. to about 145° C., about 150° C., or about 160° C.

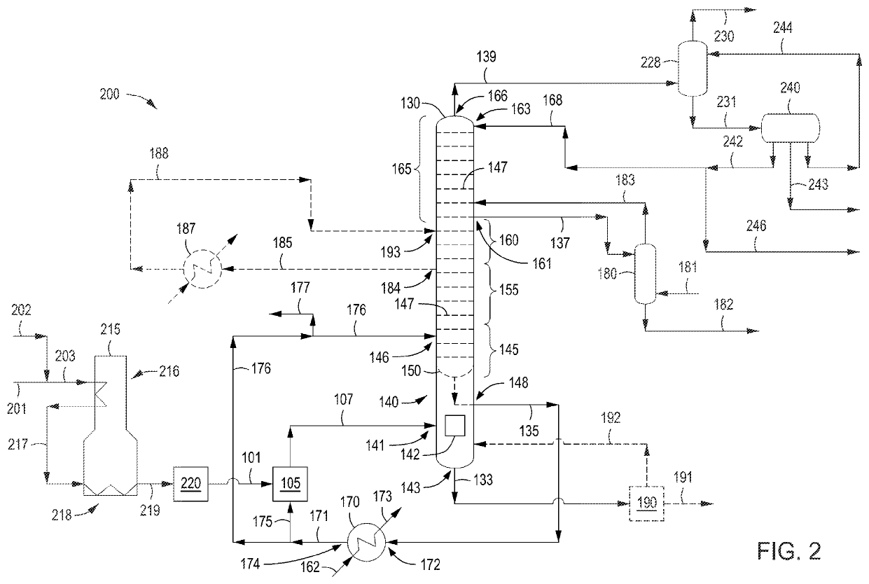

The third vapor phase fraction via line 139 in fluid communication with the vapor phase outlet 166 that can include at least a portion of the second quench medium and ethylene can be recovered from the primary fractionator 130. The third vapor phase fraction in line 139, upon exiting the primary fractionator 130, can be at a temperature of about 95° C., about 100° C., or about 105° C. to about 110° C., about 115° C., about 120° C., about 135° C., or about 150° C. The third vapor phase fraction in line 139 can include steam, molecular hydrogen, C₁-C₄ hydrocarbons, pyrolysis naphtha, or any mixture thereof. In some embodiments, the second quench medium in line 168 can be or can include pyrolysis naphtha that can be separated from the third vapor phase fraction as described in more detail below with reference to FIG. 2. In some embodiments, the pyrolysis naphtha via line 168 can be introduced into the primary fractionator 130, relative to a weight of hydrocarbons in the cooled pyrolysis effluent in line 107, at a weight ratio of about 0.45:1, about 0.47:1, or about 0.5:1 to about 0.55:1, about 0.6:1, about 0.66.1, or about 0.7:1.

In some embodiments, the third liquid phase fraction via line 137 can be introduced into a stripping stage 180 and can be contacted with steam introduced via line 181. A pyrolysis gas oil product via line 182 and an overhead via line 183 can be recovered from the stripping stage 180. Contacting the third liquid phase fraction with the steam can produce a pyrolysis gas oil product in line 182 that meets a desired flash point specification. The overhead can be recycled or refluxed via line 183 into the upper fractionation zone 165 above where the third liquid phase fraction is withdrawn via line 137.

In some embodiments, when the primary fractionator 130 includes the pump around zone 160, a pump around fraction via line 185 can be withdrawn from a pump around outlet 184 and introduced into a heat exchange stage 187 to produce a cooled pump around fraction via line 188. The pump around fraction in line 185 can be at a temperature of about 140° C., about 145° C., or about 150° C. to about 155° C., about 165° C., or about 170° C. A heat transfer medium or “second” heat transfer medium, e.g., water, steam, a mixture of water and steam, air, or any combination thereof, as described above with regard to heat exchange stage 170, via line 186 can be introduced into the heat exchange stage 187 and a heated second heat transfer medium, e.g., low pressure steam at a pressure of about 100 kPag to <827 kPag, can be recovered via line 189 therefrom. It should be understood that the heat exchange stage 187, similar to the heat exchange state 170, can include two or more heat exchange stages in series and/or in parallel.

The cooled pump around fraction via line 188 can be introduced into an upper portion of the pump around zone 160 via a pump around inlet 193. In some embodiments, the pump around outlet 184 can be located below the pump around inlet 193. The cooled pump around fraction in line 188 can be at a temperature of about 85° C., about 9° C., about 100° C., or about 110° C. to about 120° C., about 135° C., about 150° C., or about 160° C. In some embodiments, the cooled pump around fraction via line 188 can be introduced into the primary fractionator 130, relative to a weight of hydrocarbons in the cooled pyrolysis effluent in line 107, at a weight ratio of about 2.5:1, about 3:1, or about 3.2:1 to about 3.5:1, about 3.7:1, or about 4:1.

### Production of the Pyrolysis Effluent

FIG. 2 depicts a schematic of an illustrative system 200 for steam cracking a hydrocarbon feed 201 to produce a pyrolysis effluent, i.e., a steam cracker effluent, via line 219 and separating a plurality of products therefrom, according to one or more embodiments. For simplicity and ease of description, the pyrolysis process is described in the context of a steam cracking process. It should be understood, however, that any pyrolysis process can be used to produce the pyrolysis effluent in line 219.

The hydrocarbon feed in line 201 can be mixed, blended, combined, or otherwise contacted with water and/or steam in line 202 to produce a mixture via line 203. The mixture in line 203 can be heated in a convection section 216 of a steam cracker 215 to produce a heated mixture in line 217. The heated mixture in line 217 can be subjected to steam cracking conditions in a radiant section 218 of the steam cracker 215 to produce a steam cracker effluent via line 219. In some embodiments, when a sufficiently heavy hydrocarbon feed is present in line 201, a vapor phase product and a liquid phase product can be separated from the heated mixture in line 217 before subjecting the heated mixture to steam cracking by introducing the heated mixture into one or more separation stages. The vapor phase product can be heated to a temperature of ≥400° C. e.g., a temperature of about 425° C. to about 825° C., and subjected to steam cracking conditions to produce the steam cracker effluent in line 219. The liquid phase product, if produced/recovered, can be subjected to one or more additional upgrading processes well-known in the art. In some embodiments, the optional hydrocarbon feed separation stage and upgrading of the liquid phase product can be or include those disclosed in U.S. Pat. Nos. 7,138,047; 7,090,765; 7,097,758; 7,820,035; 7,311,746; 7,220,887; 7,244,871; 7,247,765; 7,351,872; 7,297,833; 7,488,459; 7,312,371; 6,632,351; 7,578,929; 7,235,705; and 8,158.840.

Hydrocarbon feeds that can be introduced into the steam cracker via line 201/203 can be or can include, but are not limited to, raw crude oil, desalted crude oil, gas oils, heating oil, jet fuel, diesel, kerosene, gasoline, coker naphtha, steam cracked naphtha, catalytically cracked naphtha, hydrocrackate, reformate, raffinate reformate, Fischer-Tropsch liquids, Fischer-Tropsch gases, natural gasoline, distillate, virgin naphtha, atmospheric pipestill bottoms, vacuum pipestill streams such as vacuum pipestill bottoms and wide boiling range vacuum pipestill naphtha to gas oil condensates, heavy non-virgin hydrocarbons from refineries, vacuum gas oils, heavy gas oil, naphtha contaminated with crude, atmospheric residue, heavy residue, a C4/residue admixture, naphtha/residue admixture, hydrocarbon gases/residue admixture, hydrogen/residue admixtures, waxy residues, gas oil/residue admixture, relatively light alkanes, e.g., ethane, propane, butane, pentane, or a mixture thereof, fractions thereof, or any mixture thereof. In at least some embodiments, the hydrocarbon feed can be or can include, but is not limited to, naphtha, gas oil, vacuum gas oil, a waxy residue, an atmospheric residue, a crude oil, a fraction thereof, or a mixture thereof. In some embodiments, if a raw crude oil or other hydrocarbon that includes salts will be steam cracked, the raw crude oil or other hydrocarbon can optionally be subjected to pretreatment, e.g., desalting, to remove at least a portion of any salts contained in the raw crude oil or other hydrocarbon before heating the hydrocarbon feed to produce the heated mixture. In some embodiments, the hydrocarbon feed can be primarily composed of relatively light hydrocarbons such as C₂ to C₈ alkanes. Suitable hydrocarbon feeds can also be or include the hydrocarbons or hydrocarbon feeds disclosed in U.S. Pat. Nos. 7,993,435; 8,277,639; 8,696,888; 9,327,260; 9,637,694; 9,657,239; and 9,777,227; and International Patent Application Publication No. WO 2018/111574.

The steam cracking conditions can include, but are not limited to, one or more of: exposing the hydrocarbon feed to a temperature (as measured at a radiant outlet of the steam cracker) of 400° C., e.g., a temperature of about 700° C., about 800° C., or about 900° C. to about 950° C., about 1,000° C., or about 1050° C., a pressure of about 0.1 bar to about 5 bars (absolute), and/or a steam cracking residence time of about 0.01 seconds to about 5 seconds. In some embodiments, the hydrocarbon feed can be steam cracked according to the processes and systems disclosed in U.S. Pat. Nos. 6,419,885; 7,993,435; 9,637,694; and 9,777,227; U.S.

Patent Application Publication No. 2018/0170832; and International Patent Application Publication No. WO 2018/111574. The steam cracker effluent in line 219 can be at a temperature of ≥300° C., ≥400° C., ≥500° C. 600° C., or ≥700° C., or ≥800° C., or more.

The steam cracker effluent in line 219 can be cooled to produce a first cooled steam cracker effluent. In some embodiments, the steam cracker effluent in line 219 can be directly contacted with an optional quench fluid, e.g., a transfer line exchanger “TLE”, and/or indirectly cooled via one or more heat exchangers in a heat exchange stage 220 to produce the first cooled steam cracker or pyrolysis effluent via line 101.

The first cooled steam cracker or pyrolysis effluent via line 101 can be introduced into the quench fitting to produce a second cooled steam cracker or pyrolysis effluent in line 107. The second cooled steam cracker or pyrolysis effluent in line 107 can be introduced into the primary fractionator 130 and a steam cracker or pyrolysis tar product via line 133, a steam cracker or pyrolysis quench oil via line 135, a steam cracker or pyrolysis gas oil via line 137, and an overhead product via line 139 can be recovered from the primary fractionator 130 as discussed and described above with reference to FIG. 1.

The overhead via line 139 can be introduced into a quench tower 228 along with quench water. e.g., a recycled quench water, via line 244 to cool the overhead product. A process gas that can include ethylene, propylene, or ethylene and propylene can be recovered via line 230 and a mixture that includes steam cracker naphtha and quench water via line 231 can be conducted away from the quench tower 228. It should be understood that, while shown as being separate vessels, the quench tower 228 can be integrated with the primary fractionator 130.

The mixture of steam cracker naphtha and quench water in line 231 can be introduced into one or more separators 240. A steam cracker or pyrolysis naphtha via line 242, quench water via line 243, and the recycle quench water via line 244 can be conducted away from the separator 240. The quench water via line 243 can be removed from the system, e.g., introduced into a wastewater treatment process, sent a sour water stripper, dilution steam generation system, etc. The recycle quench water via line 244 can be recycled to the quench tower 228. In some embodiments, the recycle quench water via line 244 can be cooled, e.g., by air and/or water, and recycled to the quench tower 228. In some embodiments, the recycle quench water via line 244 can be recycled to the quench tower 228 as a single return and/or split into multiple returns to the quench tower 228 and/or other process equipment.

A portion of the steam cracker naphtha via lines 242 and 246 can be removed and further processed. A portion of the steam cracker naphtha via lines 242 and 168 can be recycled to the upper fractionation zone as a reflux. The steam cracker naphtha in line 242 can have a final boiling point of ≤260° C. as measured according to ASTM D2887-18. In some embodiments, the steam cracker naphtha can have a final boiling point of about 220° C., about 221° C., about 225° C., or about 230° C. to about 235° C., about 240° C., about 245° C., about 250° C., or about 255° C. In some embodiments, the amount of steam cracker gas oil via line 137 conducted away from the primary fractionator 130 can be controlled or adjusted to maintain recovery of a steam cracker naphtha in line 242 that has a final boiling point of ≤260° C. as measured according to ASTM D2887-18. The amount of steam cracker naphtha recycled via lines 242 and 168 relative to the cooled steam cracker effluent introduced via line 107 into the primary fractionator 130 can be adjusted or controlled to provide a desired temperature and/or liquid loading within the upper fractionation zone 165 of the primary fractionator 130.

Suitable steam crackers, process gas recovery configurations, other equipment, and process conditions can include those disclosed in U.S. Pat. Nos.: 6,419,885; 7,560,019; 7,993,435; 8,105,479; 8,197,668; 8,882,991; 8,894,844; 9,637,694; 9,777,227; U.S. Patent Application Publication Nos.: 2014/0061096; 2014/0357923; 2016/0376511; 2018/0170832; 2019/0016975; and WO Publication No.: WO 2018/111574.

### EXAMPLES

The foregoing discussion can be further described with reference to the following non-limiting prophetic examples.

Two simulations are carried out that separate a steam cracker effluent in the primary fractionator 130 described herein. A first simulation (base case) uses a primary fractionator 130 that includes the flash zone 140, the vapor distribution device 150, the quench zone 145, the lower fractionation zone 155 without any trays, the pump around zone 160, and the upper fractionation zone 165. A second simulation uses the same primary fractionator 130 as the first simulation but two trays are disposed within the lower fractionation zone 155. The first simulation produces a base amount of high pressure steam (quantified in MW), medium pressure steam (quantified in MW), low pressure steam (quantified m MW), and recovers a base amount (in kg/hr) of steam cracker naphtha. As shown in Table 1 below, the second simulation produces approximately 1 MW more of high pressure steam, about 10 MW more of medium pressure steam, and about 500 kg/hr more of steam cracker naphtha.

TABLE 1

| Simulation | HP Steam, MW | MP steam, MW | LP steam, MW | SCN, kg/hr |
|---|---|---|---|---|
| First | Base | Base | Base | Base |
| Second | 1 | +10 | −10 | +500 |

The increase in medium pressure steam in the second simulation corresponds to an approximately 1% improvement in steam cracker naphtha and an approximately 5% increase in medium pressure steam over the first simulation.

In addition to the increase in steam cracker naphtha and energy recovered, shown above in Table 1, the lower fractionation section 155 also facilitates fractionation of the quench oil components from the steam cracker gas oil product. It is important that the heavier quench oil components are retained in the quench oil to avoid or reduce make-up quench oil requirements. The steam cracker gas oil is typically recovered from the primary fractionator 130 at a temperature of about 120° C. to about 145° C. As shown in Table 2 below, the final boiling point of the steam cracker gas oil is greater when the lower fractionation zone 155 does not include the two trays.

TABLE 2

| Simulation | SCGO, IBP | SCGO, FBP |
|---|---|---|
| First | 167° C. | 266° C. |
| Second | 168° C. | 262° C. |

### Listing of Embodiments

This disclosure may further include the following non-limiting embodiments.

A1. A process for fractionating a pyrolysis effluent, comprising: introducing a pyrolysis effluent into a flash zone located within a fractionator; separating the pyrolysis effluent into a first liquid phase fraction and a first vapor phase fraction within the flash zone; recovering a pyrolysis tar comprising the first liquid phase fraction from the flash zone; flowing the first vapor phase fraction into a quench zone disposed above the flash zone; contacting the first vapor phase fraction with a first quench medium within the quench zone to produce a second liquid phase fraction and a second vapor phase fraction; recoverng a pyrolysis quench oil comprising the second liquid phase fraction and at least a portion of the first quench medium from the quench zone; flowing the second vapor phase fraction into a fractionation zone disposed above the quench zone; contacting the second vapor phase fraction with a second quench medium within the fractionation zone to produce a third liquid phase fraction and a third vapor phase fraction; recovering a pyrolysis gas oil comprising the third liquid phase fraction from the fractionation zone; recovering the third vapor phase fraction comprising at least a portion of the second quench medium and a process gas comprising ethylene from the fractionation zone; and indirectly transferring heat from at least a portion of the pyrolysis quench oil to a heat transfer medium in a heat exchange stage to produce a cooled pyrolysis quench oil and a heated heat transfer medium, wherein the first quench medium comprises at least a portion of the cooled pyrolysis quench oil.

A2. The process of A1, further comprising recovering a pyrolysis naphtha and the process gas from the third vapor phase fraction, wherein the second quench medium comprises a portion of the pyrolysis naphtha separated from the third vapor phrase fraction.

A3. The process of A1 or A2, wherein: the heat transfer medium comprises water, steam, or a mixture thereof, and the heated heat transfer medium comprises low pressure steam at a pressure of about 100 kPag to <827 kPag, medium pressure steam at a pressure of about 827 kPag to about 1,720 kPag, or a combination thereof.

A4. The process of A1 or A2, wherein: the heat transfer medium comprises water, steam, or a mixture thereof, and the heated heat transfer medium comprises medium pressure steam at a pressure of about 827 kPag to about 1,720 kPag.

A5. The process of any of A1 to A4, wherein the steam cracker quench oil recovered from the quench zone has a viscosity of ≤5 cP at a temperature of about 60° C., as measured according to ASTM D2171/D2171M-18.

A6. The process of any of A1 to A5, wherein a weight ratio of the pyrolysis quench oil to the pyrolysis tar recovered from the fractionator is about 15:1 to about 200:1.

A7. The process of any of A1 to A6, wherein the pyrolysis effluent comprises coke particles, and wherein the pyrolysis quench oil comprises ≥10 wt % of the coke particles present in the pyrolysis effluent.

A8. The process of any of A1 to A7, wherein the pyrolysis effluent comprises coke particles, wherein the tar product comprises ≥50 wt % of the coke particles present in the pyrolysis effluent, and wherein ≥50 wt % of any coke particles not removed from the fractionator via the tar product remain in the flash zone.

A9. The process of any of A1 to A8, wherein the pyrolysis quench oil forms less than 15 wppm of insoluble polymer when heat soaked at a temperature of about 160° C. for 6 hours.

A10. The process of any of A1 to A9, wherein the first vapor phase fraction flows into the quench zone through a chimney tray, a dual flow tray, or a baffle tray.

A11. The process of any of A1 to A10, wherein the quench zone comprises one or more jet trays, one or more dual flow trays, one or more fixed valve trays, one or more sieve trays, one or more baffle trays, one or more angle iron trays, one or more draw off trays, one or more chimney trays, one or more shed deck trays, one or more disk trays, one or more donut trays, one or more side by side-splash trays, or a combination thereof disposed therein to facilitate separation of the first vapor phrase fraction and the second liquid phase fraction therein.

A12. The process of any of A1 to A11, wherein the first vapor phase fraction is at a temperature of about 225° C. to about 300° C. as the first vapor phase fraction flows into the quench zone, and wherein the second vapor phase fraction is at a temperature of about 160° C. to about 200° C. as the second vapor phase fraction flows into the fractionation zone.

A13. The process of any of A1 to A12, wherein the fractionation zone comprises a lower fractionation zone and an upper fractionation zone, and wherein a pump around zone is disposed between the lower fractionation zone and the upper fractionation zone.

A14. The process of A13, further comprising: withdrawing a pump around fraction from a lower portion of the pump around zone into the pump around loop; cooling the pump around fraction to produce a cooled pump around fraction; and introducing the cooled pump around fraction into an upper portion of the pump around zone.

A15. The process of A14, wherein cooling the pump around fraction produces low pressure steam at a pressure of about 100 kPag to <827 kPag.

A16. The process of A14 or A15, wherein the pyrolysis gas oil is recovered from a lower portion of the upper fractionation zone.

A17. The process of any of A14 to A16, wherein the pyrolysis gas oil is at a temperature of about 120° C. to about 160° C. when recovered from the pump around zone.

A18. The process of any of A14 to A17, wherein the cooled pump around fraction is introduced into the pump around zone at a location that is below a location where the pyrolysis gas oil is recovered.

A19. The process of any of A1 to A18, wherein: the pyrolysis effluent is at a temperature of ≤350° C. when introduced into the flash zone, the pyrolysis tar is at a temperature of about 235° C. to about 315° C. when recovered from the flash zone; the first vapor phase fraction is at a temperature of about 235° C. to about 315° C. as the first vapor phase fraction flows into the quench zone, the pyrolysis quench oil is at a temperature of about 185° C. to about 250° C. when recovered from the quench zone; the second vapor phase fraction is at a temperature of about 160° C. to 200° C. as the second vapor phase fraction flows into the fractionation zone; the pyrolysis gas oil is at a temperature of about 120° C. to about 145° C. when recovered from fractionation zone; and the third vapor phase fraction is at a temperature of about 95° C. to about 120° C. when recovered from the fractionation zone.

A20. The process of any of A1 to A19, wherein a composition of the pyrolysis quench oil recovered from the quench zone and a composition of the cooled pyrolysis quench oil contacted with the first vapor phase fraction within the quench zone are the same.

A21. The process of any of A1 to A20, wherein the pyrolysis quench oil recovered from the quench zone is not subjected to filtration.

A22. The process of any of A1 to A21, wherein the cooled pyrolysis effluent is at a temperature of ≥225° C., ≥240° C., ≥250° C., or ≥260° C. and ≤350° C. when introduced into the flash zone.

B1. A primary fractionator for a pyrolysis system, comprising: a flash zone comprising a pyrolysis effluent inlet and a pyrolysis tar outlet; a quench zone disposed above the flash zone comprising a pyrolysis quench oil inlet and a pyrolysis quench oil outlet; a vapor distribution device disposed between the flash zone and the quench zone, the vapor distribution device configured to allow a vapor to flow therethrough from the flash zone and into the quench zone and configured to collect a liquid thereon within the quench zone; and a fractionation section disposed above the quench zone comprising a pyrolysis gas oil outlet, a vapor phase outlet, and a reflux inlet.

B2. A system for producing and processing a pyrolysis effluent, comprising: a pyrolysis reactor comprising a pyrolysis effluent outlet; a quench fitting comprising a first inlet in fluid communication with the pyrolysis effluent outlet, a second inlet, and an outlet, wherein the quench fitting is configured to mix a pyrolysis effluent introduced into the first inlet and a quench medium introduced into the second inlet to produce a cooled pyrolysis effluent; and a primary fractionator comprising: a flash zone comprising a pyrolysis effluent inlet and a pyrolysis tar outlet; a quench zone disposed above the flash zone comprising a pyrolysis quench oil inlet and a pyrolysis quench oil outlet; a vapor distribution device disposed between the flash zone and the quench zone, the vapor distribution device configured to allow a vapor to flow therethrough from the flash zone and into the quench zone and configured to collect a liquid thereon within the quench zone; and a fractionation section disposed above the quench zone comprising a pyrolysis gas oil outlet, a vapor phase outlet, and a reflux inlet.

B3. The primary fractionator or system of B1 or B2, wherein the pyrolysis quench oil outlet is in fluid communication with an inlet of a pyrolysis quench oil heat exchange stage configured to indirectly transfer heat from a pyrolysis quench oil to a heat transfer medium, and wherein the pyrolysis quench oil inlet is in fluid communication with an outlet of the pyrolysis heat exchange stage.

B4. The primary fractionator or system of any of B1 to B3, wherein the fractionation zone comprises a lower fractionation zone and an upper fractionation zone, and wherein a pump around zone is disposed between the lower fractionation zone and the upper fractionation zone.

B5. The primary fractionator or system of B4, wherein the pump around zone comprises one or more jet trays, one or more dual flow trays, one or more baffle trays, one or more fixed valve trays, one or more sieve trays, one or more angle iron trays, one or more draw off trays, one or more chimney trays, one or more shed deck trays, one or more disk trays, one or more donut trays, one or more side by side-splash trays, or a combination thereof disposed therein.

B6. The primary fractionator or system of B4 or B5, wherein the pump around zone comprises a pump around outlet in fluid communication with an inlet of a pump around heat exchange stage and a pump around inlet in fluid communication with an outlet of the pump around heat exchange stage, and wherein the pump around outlet is located below the pump around inlet.

B7. The primary fractionator or system of any of B4 to B6, wherein the pyrolysis gas oil outlet is located above the pump around outlet and the pump around inlet.

B8. The primary fractionator or system of any of B1 to B7, wherein the vapor distribution device comprises a chimney tray, a dual flow tray, or a baffle tray.

B9. The primary fractionator or system of any of B1 to B8, wherein the quench zone comprises one or more jet trays, one or more dual flow trays, one or more baffle trays, one or more fixed valve trays, one or more sieve trays, one or more angle iron trays, one or more draw off trays, one or more chimney trays, one or more shed deck trays, one or more disk trays, one or more donut trays, one or more side by side-splash trays, or a combination thereof disposed therein.

B10. The primary fractionator or system of any of B1 to B9, wherein the lower fractionation zone and the upper fractionation zone each comprise one or more fixed valve trays, one or more sieve trays, one or more dual flow trays, or a combination thereof disposed therein.

B11. The primary fractionator or system of any of B1 to B10, wherein the pyrolysis effluent inlet is in fluid communication with a feed distribution device.

B12 The primary fractionator or system of any of B1 to B11, wherein the feed distribution device comprises a vapor horn, an annular ring, a V-baffle, a perforated pipe distributor, a dual flow tray, or any combination thereof.

B13. The system of any of B2 to B12, wherein the system further comprises a heat exchange stage comprising a pyrolysis effluent inlet in fluid communication with the pyrolysis effluent outlet, a heat transfer medium inlet, a cooled pyrolysis effluent outlet, and a heated heat transfer medium outlet, the heat exchange stage configured to indirect transfer heat from the pyrolysis effluent to a heat transfer medium.

B14. The system of any of B2 to B13, wherein the system further comprises a transfer line exchanger having a first inlet in fluid communication with the pyrolysis effluent outlet, a second inlet, and an outlet, the transfer line exchanger configured to mix a pyrolysis effluent introduced into the first inlet and a quench medium introduced into the second inlet, and wherein the outlet is in fluid communication with first inlet of the quench fitting.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for fractionating a pyrolysis effluent, comprising:
introducing a pyrolysis effluent into a flash zone located within a fractionator;
separating the pyrolysis effluent into a first liquid phase fraction and a first vapor phase fraction within the flash zone;
recovering a pyrolysis tar comprising the first liquid phase fraction from the flash zone;
flowing the first vapor phase fraction into a quench zone disposed above the flash zone;
contacting the first vapor phase fraction with a first quench medium within the quench zone to produce a second liquid phase fraction and a second vapor phase fraction;
recovering a pyrolysis quench oil comprising the second liquid phase fraction and at least a portion of the first quench medium from the quench zone;
flowing the second vapor phase fraction into a fractionation zone disposed above the quench zone;
contacting the second vapor phase fraction with a second quench medium within the fractionation zone to produce a third liquid phase fraction and a third vapor phase fraction;
recovering a pyrolysis gas oil comprising the third liquid phase fraction from the fractionation zone;
recovering the third vapor phase fraction comprising at least a portion of the second quench medium and a process gas comprising ethylene from the fractionation zone; and
indirectly transferring heat from at least a portion of the pyrolysis quench oil to a heat transfer medium in a heat exchange stage to produce a cooled pyrolysis quench oil and a heated heat transfer medium, wherein the first quench medium comprises at least a portion of the cooled pyrolysis quench oil.

2. The process of claim 1, further comprising recovering a pyrolysis naphtha and the process gas from the third vapor phase fraction, wherein the second quench medium comprises a portion of the pyrolysis naphtha separated from the third vapor phrase fraction.

3. The process of claim 1, wherein:
the heat transfer medium comprises water, steam, or a mixture thereof, and
the heated heat transfer medium comprises low pressure steam at a pressure of about 100 kPag to <827 kPag, medium pressure steam at a pressure of about 827 kPag to about 1,720 kPag, or a combination thereof.

4. The process of claim 1, wherein:
the heat transfer medium comprises water, steam, or a mixture thereof, and
the heated heat transfer medium comprises medium pressure steam at a pressure of about 827 kPag to about 1,720 kPag.

5. The process of claim 1, wherein the steam cracker quench oil recovered from the quench zone has a viscosity of ≤5 cP at a temperature of about 60° C., as measured according to ASTM D2171/D2171M-18.

6. The process of claim 1, wherein a weight ratio of the pyrolysis quench oil to the pyrolysis tar recovered from the fractionator is about 15:1 to about 200:1.

7. The process of claim 1, wherein the pyrolysis effluent comprises coke particles, and wherein the pyrolysis quench oil comprises ≤10 wt % of the coke particles present in the pyrolysis effluent.

8. The process of claim 1, wherein the pyrolysis effluent comprises coke particles, wherein the tar product comprises ≥50 wt % of the coke particles present in the pyrolysis effluent, and wherein ≥50 wt % of any coke particles not removed from the fractionator via the tar product remain in the flash zone.

9. The process of claim 1, wherein the pyrolysis quench oil forms less than 15 wppm of insoluble polymer when heat soaked at a temperature of about 160° C. for 6 hours.

10. The process of claim 1, wherein the first vapor phase fraction flows into the quench zone through a chimney tray, a dual flow tray, or a baffle tray.

11. The process of claim 1, wherein the quench zone comprises one or more jet trays, one or more dual flow trays, one or more fixed valve trays, one or more sieve trays, one or more baffle trays, one or more angle iron trays, one or more draw off trays, one or more chimney trays, one or more shed deck trays, one or more disk trays, one or more donut trays, one or more side by side-splash trays, or a combination thereof disposed therein to facilitate separation of the first vapor phrase fraction and the second liquid phase fraction therein.

12. The process of claim 1, wherein the first vapor phase fraction is at a temperature of about 225° C. to about 300° C. as the first vapor phase fraction flows into the quench zone, and wherein the second vapor phase fraction is at a temperature of about 160° C. to about 200° C. as the second vapor phase fraction flows into the fractionation zone.

13. The process of a claim 1, wherein the fractionation zone comprises a lower fractionation zone and an upper fractionation zone, and wherein a pump around zone is disposed between the lower fractionation zone and the upper fractionation zone.

14. The process of claim 13, further comprising:
withdrawing a pump around fraction from a lower portion of the pump around zone into the pump around loop;
cooling the pump around fraction to produce a cooled pump around fraction; and
introducing the cooled pump around fraction into an upper portion of the pump around zone.

15. The process of claim 14, wherein cooling the pump around fraction produces low pressure steam at a pressure of about 100 kPag to <827 kPag.

16. The process of claim 14, wherein the pyrolysis gas oil is recovered from a lower portion of the upper fractionation zone.

17. The process of claim 16, wherein the pyrolysis gas oil is at a temperature of about 120° C. to about 160° C. when recovered from the pump around zone.

18. The process of claim 16, wherein the cooled pump around fraction is introduced into the pump around zone at a location that is below a location where the pyrolysis gas oil is recovered.

19. The process of claim 1, wherein:
the pyrolysis effluent is at a temperature of ≤350° C. when introduced into the flash zone,
the pyrolysis tar is at a temperature of about 235° C. to about 315° C. when recovered from the flash zone;
the first vapor phase fraction is at a temperature of about 235° C. to about 315° C. as the first vapor phase fraction flows into the quench zone,
the pyrolysis quench oil is at a temperature of about 185° C. to about 250° C. when recovered from the quench zone;
the second vapor phase fraction is at a temperature of about 160° C. to 200° C. as the second vapor phase fraction flows into the fractionation zone;
the pyrolysis gas oil is at a temperature of about 120° C. to about 145° C. when recovered from fractionation zone; and
the third vapor phase fraction is at a temperature of about 95° C. to about 120° C. when recovered from the fractionation zone.

20. A primary fractionator for a pyrolysis system, comprising:
a flash zone comprising a pyrolysis effluent inlet and a pyrolysis tar outlet;
a quench zone disposed above the flash zone comprising a pyrolysis quench oil inlet and a pyrolysis quench oil outlet;
a vapor distribution device disposed between the flash zone and the quench zone, the vapor distribution device configured to allow a vapor to flow therethrough from the flash zone and into the quench zone and configured to collect a liquid thereon within the quench zone; and
a fractionation section disposed above the quench zone comprising a pyrolysis gas oil outlet, a vapor phase outlet, and a reflux inlet.

21. The primary fractionator of claim 20, wherein the pyrolysis quench oil outlet is in fluid communication with an inlet of a pyrolysis quench oil heat exchange stage configured to indirectly transfer heat from a pyrolysis quench oil to a heat transfer medium, and wherein the pyrolysis quench oil inlet is in fluid communication with an outlet of the pyrolysis heat exchange stage.

22. The primary fractionator of claim 20, wherein the fractionation zone comprises a lower fractionation zone and an upper fractionation zone, and wherein a pump around zone is disposed between the lower fractionation zone and the upper fractionation zone.

23. The primary fractionator of claim 22, wherein the pump around zone comprises one or more jet trays, one or more dual flow trays, one or more baffle trays, one or more fixed valve trays, one or more sieve trays, one or more angle iron trays, one or more draw off trays, one or more chimney trays, one or more shed deck trays, one or more disk trays, one or more donut trays, one or more side by side-splash trays, or a combination thereof disposed therein.

24. The primary fractionator of claim 22, wherein the pump around zone comprises a pump around outlet in fluid communication with a pump around heat exchange stage and a pump around inlet in fluid communication with the pump around heat exchange stage, and wherein the pump around outlet is located below the pump around inlet.

25. The primary fractionator of claim 24, wherein the pyrolysis gas oil outlet is located above the pump around outlet and the pump around inlet.

26. The primary fractionator of claim 22, wherein the lower fractionation zone and the upper fractionation zone each comprise one or more fixed valve trays, one or more sieve trays, one or more dual flow trays, or a combination thereof disposed therein.

27. The primary fractionator of claim 20, wherein the vapor distribution device comprises a chimney tray, a dual flow tray, or a baffle tray.

28. The primary fractionator of claim 20, wherein the quench zone comprises one or more jet trays, one or more dual flow trays, one or more baffle trays, one or more fixed valve trays, one or more sieve trays, one or more angle iron trays, one or more draw off trays, one or more chimney trays, one or more shed deck trays, one or more disk trays, one or more donut trays, one or more side by side-splash trays, or a combination thereof disposed therein.

29. The primary fractionator of claim 20, wherein the pyrolysis effluent inlet is in fluid communication with a feed distribution device.

30. The primary fractionator of claim 29, wherein the feed distribution device comprises a vapor horn, an annular ring, a V-baffle, a perforated pipe distributor, a dual flow tray, or any combination thereof.

31. A system for producing and processing a pyrolysis effluent, comprising:
a pyrolysis reactor comprising a pyrolysis effluent outlet;
a quench fitting comprising a first inlet in fluid communication with the pyrolysis effluent outlet, a second inlet, and an outlet, wherein the quench fitting is configured to mix a pyrolysis effluent introduced into the first inlet and a quench medium introduced into the second inlet to produce a cooled pyrolysis effluent; and
a primary fractionator comprising:
a flash zone comprising a pyrolysis effluent inlet and a pyrolysis tar outlet;
a quench zone disposed above the flash zone comprising a pyrolysis quench oil inlet and a pyrolysis quench oil outlet;
a vapor distribution device disposed between the flash zone and the quench zone, the vapor distribution device configured to allow a vapor to flow therethrough from the flash zone and into the quench zone and configured to collect a liquid thereon within the quench zone; and
a fractionation section disposed above the quench zone comprising a pyrolysis gas oil outlet, a vapor phase outlet, and a reflux inlet.
